(19) United States
(12) Patent Application Publication
(10) Pub. No.: US 2010/0252380 A1
(43) Pub. Date: Oct. 7, 2010

(54) Bicycle or motorcycle brake lever lock

(75) Inventor: Bill Nguyen, (US)

Correspondence Address: Bill Nguyen, 16536 San Pedro St., Carson, CA, 90746, US

(73) Assignee: Bill Nguyen, Carson, CA (US)

(21) Appl. No.: 12/384,343

(22) Filed: Apr. 3, 2009

(51) Int. Cl. B60R 25/08

(52) U.S. Cl. 188/265; 70/224

(57) ABSTRACT

The present invention is an anti theft device for bicycles or motorcycles, which comprise of a brake lever, mounted on the handlebar. The brake lever lock provides a strong friction on the wheel rim or brake-disk which makes the wheel un-rotational, because tensions of the brake cable always pull on the brake caliper in brake lever locks state and the brake will work normally in unlock state.

### BACKGROUND OF THE INVENTION

### Field of the Invention

The present invention relates to an anti theft device for bicycles or motorcycles, which comprise a brake lever mounted on the handlebar and the brake lever having a lock installed to lock or unlock the brake lever by a key cam lock or a combination cam lock.

It is one objective of the present invention is provide the bicycles or motorcycles. The brake lever lock provides a strong friction on the wheel rim or brake-disk which makes the wheel un-rotational, because tensions of the brake cable always pulls on the brake caliper in brake lever locks state and the brake will work normally in unlock state.

### DESCRIPTION OF THE DRAWINGS

FIG. 1 is an Isometric elevational view of the brake lever having a dial combination cam lock with taper connecting collar (14).

FIG. 2 is an Isometric elevational view of the brake lever having a dial combination cam lock with rectangle connecting collar (14B).

FIG. 3 is an Isometric elevational view of the brake lever having a key cam lock with taper connecting collar (14).

FIG. 4 is an Isometric elevational view of the brake lever having a key cam lock with rectangle connecting collar (14B).

FIG. 5 is an exploded perspective view of the brake lever and a partial cross sectional view, in order to illustrate the present invention after remove the cover FIG. 6.

FIG. 6 is a top view of the brake lever cover.

FIG. 7 is an exploded perspective view of the brake lever, brake cable, brake caliper, brake-shoes, and a partial cross sectional view of tire and the wheel rim

### DETAILED DESCRIPTION OF THE INVENTION

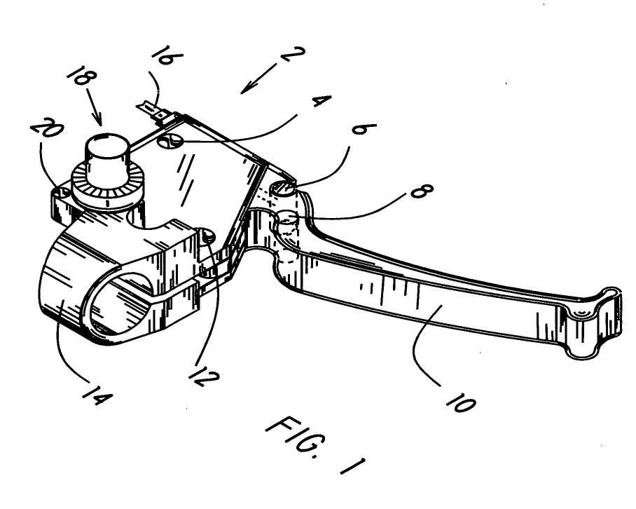

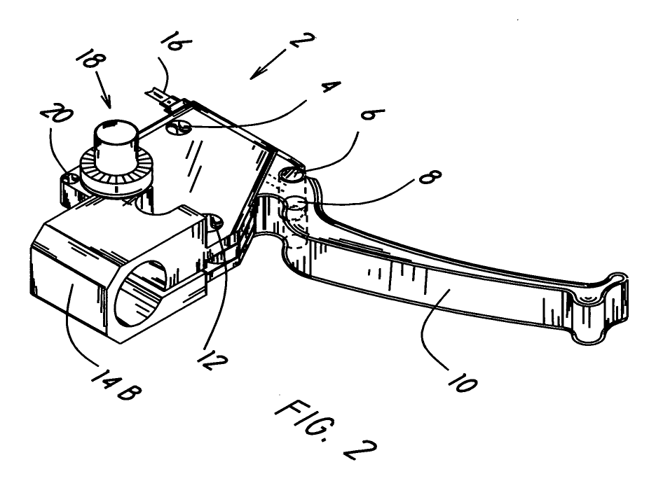

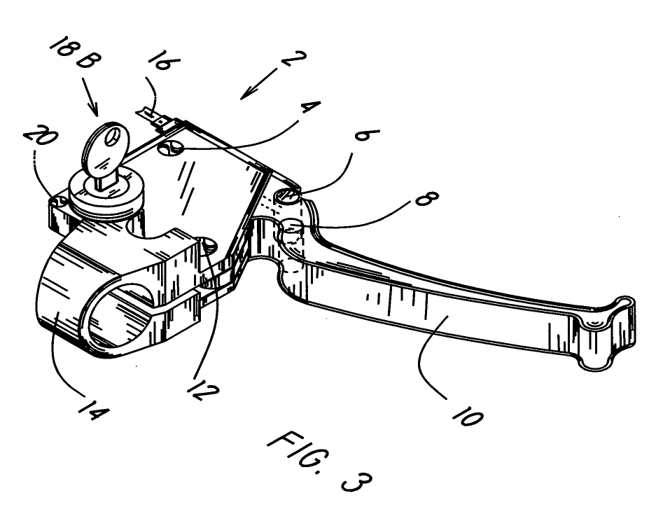

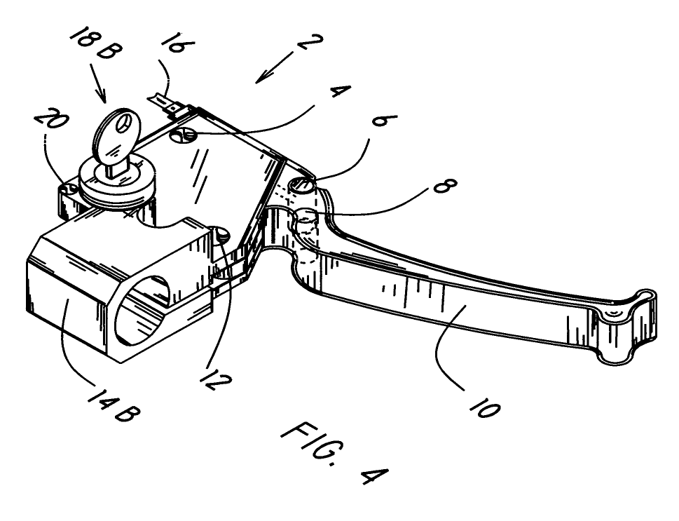

Referring now to the drawings in FIG. 1 to FIG. 5 the brake lever lock is used on the handlebar of the bicycles or motorcycles comprises: a brake lever body housing (2), a dial combination cam lock (18), a key cam lock (18B), deadbolts (4) (12)(20), a counter-bore hole and a through slot (6) for brake cable (16), a through hole for the press fit dowel-pin (8), a lever (10) having serrated teeth (19) and the pivot-hole through (21), a taper connecting collar (14) for mounting on the handlebar (29), a rectangle connecting collar (14B), a brake cable (16).

Referring to the drawing in FIG. 6 is a cover (37), having through holes for the deadbolts (15)(20)(21) to mounting on the body housing (2),

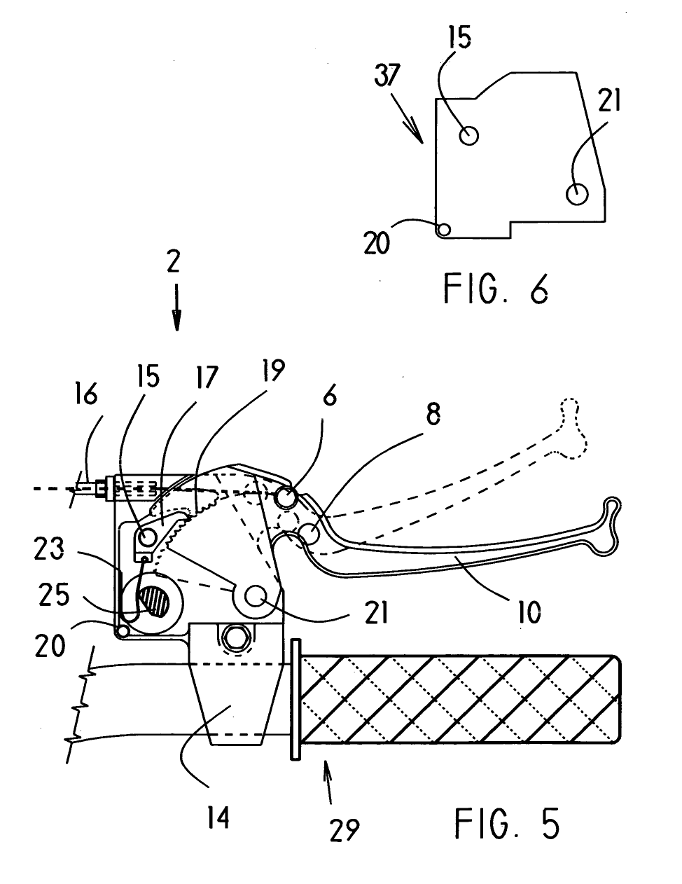

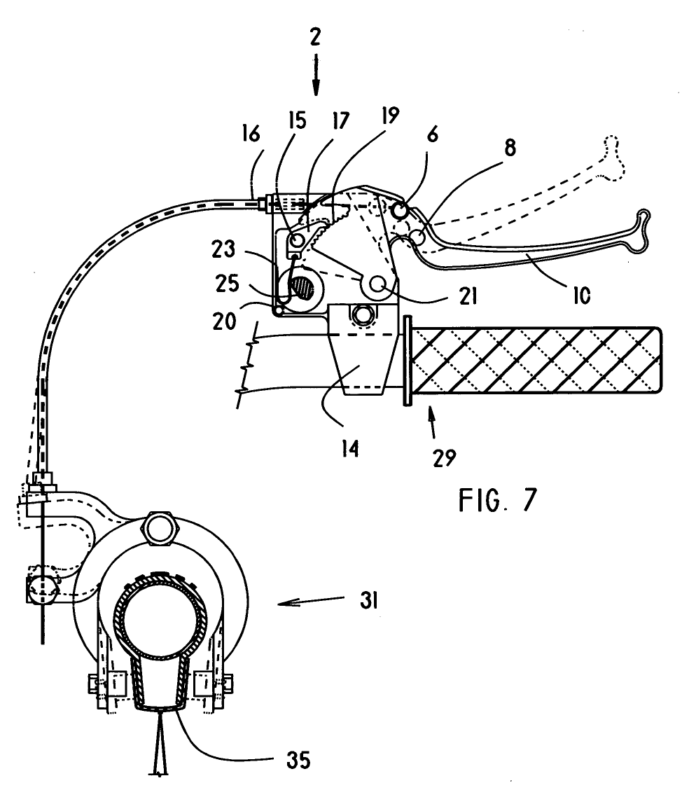

Referring to the drawings in FIG. 5 and FIG. 7, a brake cable (16), a through hole (15) for deadbolt (4), a rocker locking-arm (17) rotate-able by the U spring (23), it is lock or unlock control by turning the cam (25).

When the lever (10) is pressed the U spring (23) push the rocker locking arm down into serrated teeth (19) to lock the lever (10) from retract will makes the brake cable (16) always pulls the brake caliper (31) in pressurize position to stop the wheel rim (35) from rotationally means for preventing bicycle theft.

What is claim is:

1. An anti-theft bicycles or motorcycles brake lever lock comprising:
A lever (10) has the serrated teeth (19) and a through pivot hole (21).
Built-in a dial combination cam lock (18) turns left or right the round cam (25) to control the spring (23) to push or release the rocker arm locks (17) to snap into the serrated teeth (19) to lock the lever (10) and reverse for release the lever for normal operation.
Built-in a key cam lock (18B) turns left or right the round cam (25) to control the spring (23) to push or release the rocker arm locks (17) to snap into the serrated teeth (19) to lock the lever (10) and reverse for release the lever for normal operation.
